(19) United States
(12) Patent Application Publication
(10) Pub. No.: US 2024/0426685 A1
(43) Pub. Date: Dec. 26, 2024

(54) DEVICE AND METHOD FOR MEASURING THE TORQUE OF A ROTATING SHAFT

(71) Applicant: Kistler Holding AG, Winterthur (CH)

(72) Inventors: Simon Regitz, Niefern-Oeschelbronn (DE); Benjamin Rilling, Leonberg (DE)

(21) Appl. No.: 18/744,971

(22) Filed: Jun. 17, 2024

(30) Foreign Application Priority Data
Jun. 23, 2023 (EP) 23181140.7

(51) Int. Cl. G01L 3/10

(52) U.S. Cl. CPC G01L 3/108

(57) ABSTRACT

The invention relates to a device for measuring the torque of a shaft rotating about a longitudinal axis and includes a measurement body and an evaluation unit. The measurement body includes a measuring unit, a measuring amplifier unit and a telemetry unit and can be attached to the shaft to rotate with the shaft in the attached state. The measuring unit generates a measurement signal under the effect of the torque on the shaft in the attached state. The measuring amplifier unit amplifies the measurement signal, which the telemetry unit digitizes into a digitized amplified signal that is transmitted by the telemetry unit to the evaluation unit by wireless transmission. The principal axis of inertia of the measurement body lies on the shaft's longitudinal axis in the attached state.

### FIELD OF THE INVENTION

The invention relates to a device and a method for measuring the torque of a rotating shaft with a device that attaches to and rotates with the shaft.

### BACKGROUND OF THE INVENTION

A shaft is a machine member that rotates about an axis and has the function of transmitting a rotational movement and a torque during rotation. Such a shaft has a wide range of applications in machines, for example as a drive shaft in automotive technology, as a turbine shaft in energy technology and the like.

The torque transmitted by the shaft can be used to determine key parameters of the machines such as performance, efficiency, friction values and the like. For this reason, the torque is measured both during the development of machines and during use in the industry.

A device for measuring the torque of a rotating shaft is known from the document DE19719921A1, which device comprises a measurement body rotating with the shaft and designed as a measuring flange, and an evaluation unit. The evaluation unit comprises a stator antenna. The evaluation unit is remote from the shaft and the measurement body. The measurement body itself comprises a strain gauge, a measuring amplifier and a telemetry unit having a rotor antenna. Under the effect of the torque to be measured, the strain gauge generates a measurement signal, the measuring amplifier amplifies the measurement signal, and the telemetry unit digitizes the amplified measurement signal to obtain measurement data and sends the measurement data via the rotor antenna to the stator antenna from where the measurement data are forwarded to the evaluation unit. Parameters of the measuring amplifier such as zero point or gain factor may be adjusted using signals sent from the stator antenna to the rotor antenna.

However, users wish to utilize the device described above with shafts having a variety of diameters. For this reason, a plurality of measurement bodies are provided, the dimensions of which are adapted to the respective shaft diameter while the evaluation unit used remains the same. The measurement bodies of different sizes affect the measurement accuracy, particularly in the case of rapidly rotating shafts rotating at velocities of well over 1000 rpm which is why the comparability of the measurement signals obtained for shaft diameters of different sizes is limited.

### OBJECTS AND SUMMARY OF THE INVENTION

It is a first object of the present invention to improve the device for measuring the torque of a rotating shaft known from DE19719921A1. Thus, the measurement accuracy is to be increased. It is a further object of the present invention to provide a method that enables simple, rapid and cost-effective measurement of the torque of a rotating shaft.

These objects have been achieved by the features described hereinafter.

The invention relates to a device for measuring the torque of a rotating shaft; which device comprises a measurement body and an evaluation unit; which measurement body can be attached to the shaft and rotates with the shaft about a longitudinal axis of the shaft in the attached state; which measurement body comprises a measuring unit, a measuring amplifier unit and a telemetry unit; which measuring unit generates a measurement signal under the effect of the torque in the attached state; which measuring amplifier unit amplifies the measurement signal; which telemetry unit digitizes the amplified measurement signal which it transmits to the evaluation unit by wireless transmission; wherein the measurement body has a principal axis of inertia, which principal axis of inertia lies on the longitudinal axis in the attached state.

The invention also relates to a method for measuring the torque of a rotating shaft using a device that comprises a measurement body and an evaluation unit; which measurement body comprises a measuring unit, a measuring amplifier unit and a telemetry unit; wherein the measurement body is attached to the shaft; wherein the shaft is rotated about a longitudinal axis of the shaft and transmits the torque; wherein the measuring unit generates a measurement signal under the effect of the torque; wherein the measuring amplifier unit amplifies the measurement signal; wherein the telemetry unit digitizes the amplified measurement signal which it transmits to the evaluation unit by wireless transmission; and wherein a measurement body is provided, which measurement body has a principal axis of inertia, which principal axis of inertia lies on the longitudinal axis in the attached state.

The invention is based on the finding that the measurement body of the device for measuring the torque of a rotating shaft known from DE19719921A1 is heterogeneous in structure since it is composed of a measuring flange, a strain gauge, a measuring amplifier and a telemetry unit that comprises a rotor antenna. Furthermore, due to this heterogeneous structure it has an asymmetrical mass distribution with respect to the longitudinal axis of the rotating shaft resulting in the center of gravity of the measurement body not lying on the longitudinal axis which leads to a static imbalance, or the principal axis of inertia of the measurement body being tilted at an angle of #0° to the longitudinal axis leading to a dynamic imbalance, respectively. The imbalance resulting from the static imbalance and the dynamic imbalance causes an interference torque that is superimposed on the torque to be measured and, thus, falsifies the torque measurement. The measurement body of the device according to the invention is balanced both statically and dynamically and the interference torque is minimized and, thus, the measuring accuracy of the device is increased.

Advantageous embodiments of the invention are provided throughout the detailed description.

### BRIEF DESCRIPTION OF THE DRAWINGS

In the following, the invention is explained in more detail by way of example with reference to the figures in which

FIG. 1 is a schematic representation of the device V for measuring the torque M of a shaft W, W′ and comprising a measurement body 1, 1′ and an evaluation unit 2;

FIG. 2 is a partial view in perspective of a first embodiment of the measurement body 1 and the shaft W according to FIG. 1;

FIG. 3 is a partial view in perspective of a second embodiment of the measurement body 1′ and the shaft W′ according to FIG. 1;

FIG. 4 is a partial view in perspective of the measurement body 1, 1′ according to FIG. 1 comprising a measuring unit 12 placed between a first measurement body housing part 11a and a second measurement body housing part 11b;

FIG. 5 is an exploded view of the measurement body 1, 1′ according to FIG. 1 comprising a measuring amplifier unit 13 and a telemetry unit 14 in the first measurement body housing part 11a and comprising an energy storage unit 15 in the second measurement body housing part 11b;

FIG. 6 is a first cross-sectional view B-B along a first section line B through the first measurement body housing part 11a according to FIG. 5; and

FIG. 7 is a second cross-sectional view C-C along a second section line C through the second measurement body housing part 11b according to FIG. 5.

Throughout the figures, the same objects are denoted by the same reference numerals.

### DETAILED DESCRIPTION OF EXEMPLARY EMBODIMENTS OF THE INVENTION

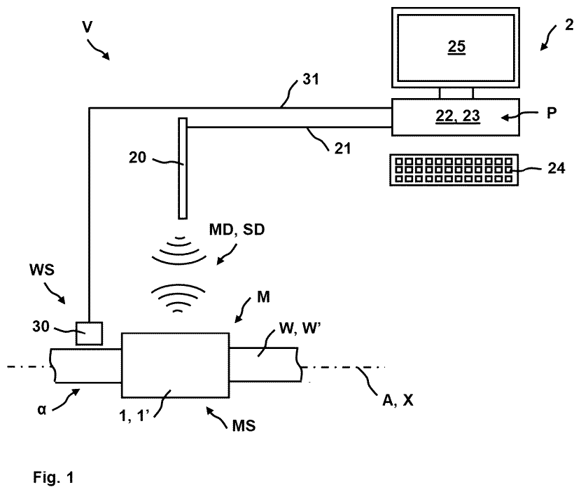

FIG. 1 shows a shaft W, W′ which can rotate about a longitudinal axis A of the shaft W, W′ and transmits a torque M during rotation. With respect to the longitudinal axis A, the shaft W, W′ is a rotationally symmetrical body and made of a mechanically resistant material such as metal, plastics and the like.

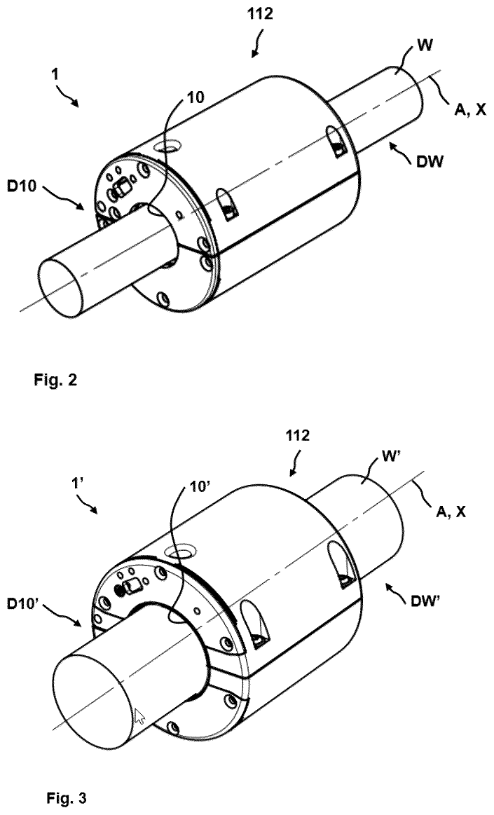

FIG. 1 also shows a device V for measuring the torque M of the shaft W, W′. Device V is composed of a measurement body 1, 1′ and an evaluation unit 2. The measurement body 1, 1′ is attached to the shaft W, W′ and rotates together with the shaft W, W′ about the longitudinal axis A. The evaluation unit 2 is remote from the shaft W, W′ and from the measurement body 1, 1′. In the description, the comparable features of a second embodiment shown in FIG. 3 are indicated by an apostrophe added to the designations of these features in the first embodiment shown in FIG. 2.

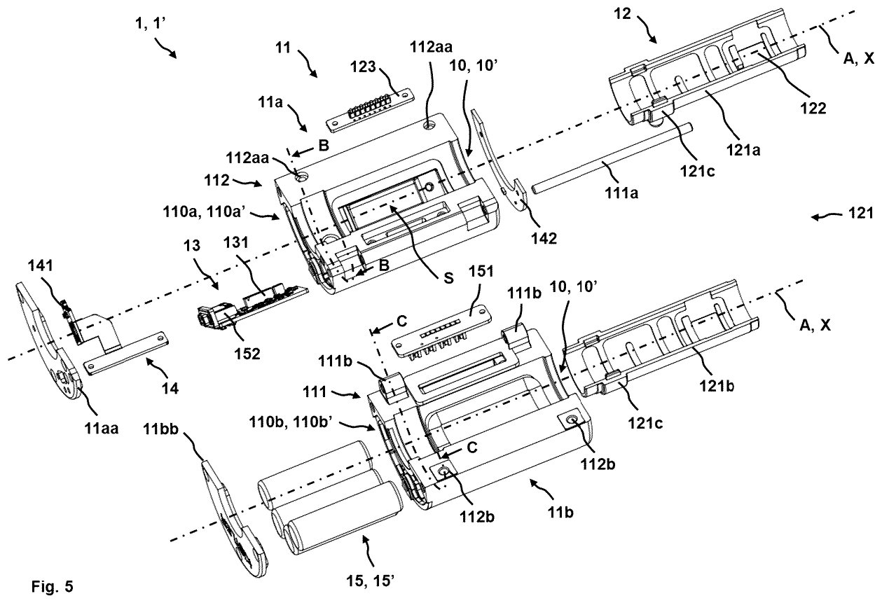

In the representations according to FIGS. 1 to 4 and the exploded view according to FIG. 5, the measurement body 1, 1′ is shaped like a hollow cylinder. The measurement body 1, 1′ comprises an axial cavity 10, 10′ in the proximity of the longitudinal axis A. The axial cavity 10, 10′ has a cavity diameter D10, D10′. The size of the cavity diameter D10, D10′ is such that it is equal to that of the shaft diameter DW, DW′ in the radial direction perpendicular to the longitudinal axis A. In the direction of the longitudinal axis A, the measurement body 1, 1′ is attached radially to the outside of the shaft W, W′. Preferably, the attachment is achieved by a form locking and a force locking connection by means of clamping. Attachment is reversible so that the measurement body 1, 1′ is selectively attached radially to the outside of the shaft W, W′.

However, shafts W, W′ may have different shaft diameters WD, WD′. Accordingly, the device comprises a variety of measurement bodies 1, 1′ having cavity diameters D1, D1′ that correspond to the different shaft diameters DW, DW′. In this respect, FIGS. 2 and 3 show two embodiments of the shaft W, W′ and of the axial cavity 10, 10′ of the measurement body 1, 1′. In the first embodiment as shown in FIG. 2, the shaft W has a shaft diameter DW of 25 mm while the shaft W′ in the second embodiment as shown in FIG. 3 has a shaft diameter DW′ of 45 mm. In a first embodiment according to FIG. 2, the measurement body 1 has a cavity diameter D10 of 25 mm while the measurement body 1′ of the second embodiment according to FIG. 3 has a cavity diameter D10′ of 45 mm. Of course, the persons skilled in the art are free to carry out the present invention with shafts and axial cavities having diameters of less than 25 mm and shafts and axial cavities having diameters larger than 45 mm.

The measurement body 1, 1′ comprises a measurement body housing 11, a measuring unit 12, a measuring amplifier unit 13, a telemetry unit 14, and an energy storage unit 15.

The measurement body housing 11 is configured to protect the measuring unit 12, the measuring amplifier unit 13, the telemetry unit 14, and the energy storage unit 15 from harmful environmental conditions such as dust, moisture and the like.

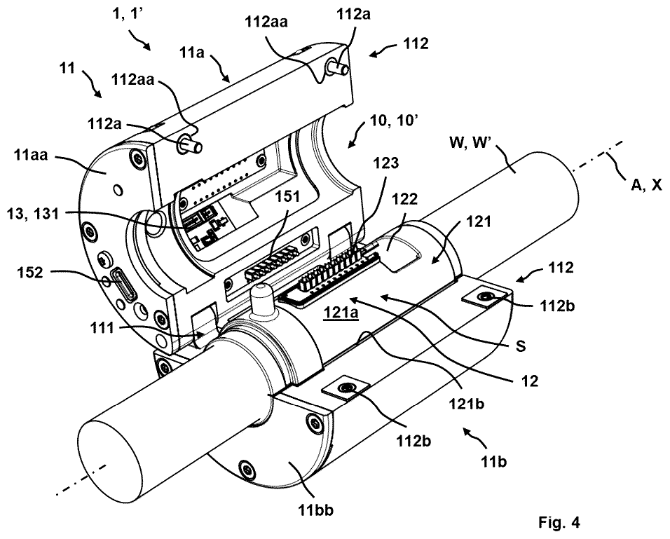

In the view according to FIG. 4 and the exploded view according to FIG. 5, the measurement body housing 11 is shown to consist of a plurality of parts and comprising a first measurement body housing part 11a and a second measurement body housing part 11b, and comprising a first measurement body closure part 11aa and a second measurement body closure part 11bb.

Preferably, the measurement body housing 11 is bisected in a plane lying in the longitudinal axis A and the two measurement body housing parts 11a, 11b have the shape of congruent halves of hollow cylinders, and the two measurement body closure parts 11aa, 11bb have the shape of halves of the end faces of hollow cylinders. Each of the two measurement body housing parts 11a, 11b is delimited by the axial cavity 10, 10′ in the proximity of the longitudinal axis A. The two measurement body housing parts 11a, 11b and the two measurement body closure parts 11aa, 11bb are made of mechanically resistant material such as metal, plastics and the like.

The first measurement body housing part 11a comprises at least one first housing cavity 110a, 110a′. The first measurement body closure part 11aa is configured to provide a tight seal for the first housing cavity 110a, 110a′ against dust and moisture. The second measurement body housing part 11b comprises at least one second housing cavity 110b, 110b′. The second measurement body closure part 11bb is configured to provide a seal for the second housing cavity 110b, 110b′ against dust and moisture. Preferably, the first and second housing cavities 110a, 110a′, 110b, 110b′ are closed by a combination of a form locking and a force locking connection such as a screw connection.

In the exploded view according to FIG. 5, the first housing cavity 110a, 110a′ accommodates the measuring amplifier unit 13 and the telemetry unit 14, and the second housing cavity 110b, 110b′ accommodates the energy storage unit 15.

In the following, the first measurement body housing part 11a equipped with the measuring amplifier unit 13 and the telemetry unit 14 in the first housing cavity 110a, 110a′ and sealed by the first measurement body closure part 11a will also be named the first measurement body part 1a. Accordingly, the second measurement body housing part 11b equipped with the energy storage unit 15 in the second housing cavity 110b, 110b′ and sealed by the second measurement body closure part 11b will be named the second measurement body part 1b hereinbelow.

Preferably, as shown in FIG. 4 for example, the two measurement body housing parts 11a, 11b comprise a hinge unit 111 and a connecting unit 112.

The hinge unit 111 is configured to hold the two measurement body housing parts 11a, 11b together so that they are able to pivot about the longitudinal axis A. In the exploded view according to FIG. 5, the hinge unit 111 is a hinge comprising at least one pin 111a and a plurality of sockets 111b. The hinge unit 111 holds the two measurement body housing parts 11a, 11b together on one side. By pivoting about the longitudinal axis A, it is possible to bring the two measurement body housing parts 11a, 11b reversibly from an opened state to a closed state while they are held together by the hinge unit 111.

The connecting unit 112 is configured to detachably connect the two measurement body housing parts 11a, 11b to each other. Preferably, the connecting unit 112 is a combination of a form locking connection and a force locking connection such as a screw connection, a plug connection and the like. In the representation according to FIG. 4 and the exploded view according to FIG. 5, the connecting unit 112 consists of at least one screw 112a and at least one through hole 112aa in first measurement body housing part 11a and at least one threaded hole 112b in the second measurement body housing part 11b. A head of the screw 112a is supported in the through hole 112aa and a thread of the screw 112a protrudes through the through hole 112aa and can be screwed in the threaded hole 112b. It is only possible to pivot the two measurement body housing parts 11a, 11b with respect to one another about the longitudinal axis A after the connecting unit 112 has been released. Releasing the connecting unit 112 is also selectively reversible by the user.

The views according to FIGS. 2 and 3 show the two measurement body housing parts 11a, 11b in the closed state held together by the hinge unit 111, which is hidden from view on one side, and connected to each other by the connecting unit 112 on the other side. In the view according to FIG. 4, the connecting unit 112 has been released and the two measurement body housing parts 11a, 11b have been brought in the opened state by pivoting about the longitudinal axis A and are held together on one side only by the hinge unit 111.

In the closed state the two measurement body parts 1a, 1b are balanced, i.e. a center of gravity S of the measurement body 1, 1′ schematically indicated in FIGS. 4 and 5 lies on the longitudinal axis A and, further, a principal axis of inertia X of the measurement body 1, 1′ lies on the longitudinal axis A and runs in an angle of 0°, i.e. not tilted, with respect to the longitudinal axis A.

There are only a few degrees of freedom for use in balancing because the external dimensions and the weight of the measuring amplifier unit 13 and the telemetry unit 14 located in the first measurement body housing part 11a are given as are the external dimensions and the weight of the energy storage unit 15 located in the second measurement body housing part 11b. Furthermore, the shaft diameter DW, DW′ and, thus, also the cavity diameter D10, D10′ of the axial cavity 10, 10′ is given.

Thus, the degrees of freedom remaining for balancing are the weight and the weight distribution of each of the two measurement body housing parts 11a, 11b. The weight and the weight distribution of the first and second measurement body housing parts 11a and 11b are adjusted for balancing such that the two measurement body parts 1a, 1b are balanced in the closed state.

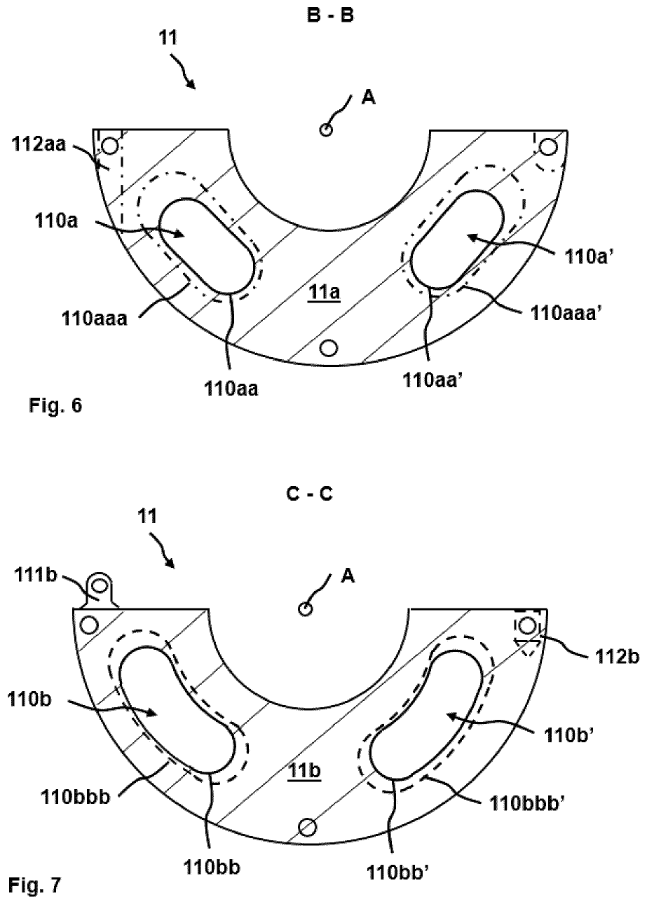

For illustration, FIG. 6 shows a representation of a first cross-section B-B along a first section line B through the first measurement body housing part 11a according to FIG. 5, and FIG. 7 shows a view of a second cross-section C-C along a second section line C through the second measurement body housing part 11b according to FIG. 5.

The view according to FIG. 6 shows the first housing cavity 110a, 110a′ as a first cavity 110a in the shape of an oblong hole for accommodating the measuring amplifier unit 13 and as a further first cavity 110a′ in the shape of an oblong hole for accommodating the telemetry unit 14. The first housing cavity 110a having the shape of an oblong hole is delimited by a first edge 110aa to the outside of the first measurement body housing part 11a. On its inside, the first housing cavity 110a having the shape of an oblong hole comprises at least one first undercut 110aaa shown as a dash-dotted line. The further first housing cavity 110a′ having the shape of an oblong hole is delimited by a further first edge 110aa′ to the outside of the first measurement body housing part 11a. On its inside, the further first housing cavity 110a′ having the shape of an oblong hole comprises at least one further first undercut 110aaa′ shown as a dash-dotted line. In the following, the first undercut 110aaa and the further first undercut 110aaa′ will also be referred to as the first undercut 110aaa, 110aaa′. The weight and weight distribution of the first measurement body housing part 11a are adjusted via the size and shape of the first undercut 110aaa, 110aaa′ so that the principal axis of inertia X of the measurement body 1, 1′ in the attached state lies on the longitudinal axis A.

In the view according to FIG. 7, the second housing cavity 110b, 110b′ consists of a first kidney-shaped cavity 110b for accommodating two first lithium-ion batteries of the energy storage unit 15 and of a further first kidney-shaped cavity 110b′ for accommodating two more lithium-ion batteries of the energy storage unit 15. The second kidney-shaped housing cavity 110b is delimited by a second edge 110bb to the outside of the second measurement body housing 11b. On its inside, the second kidney-shaped housing cavity 110b comprises at least one second undercut 110bbb shown as a dash-dotted line. The further second kidney-shaped housing cavity 110b′ is delimited by a further second edge 110bb′ to the outside of the second measurement body housing 11b. On its inside, the further second kidney-shaped housing cavity 110b′ comprises at least one further second undercut 110bbb′ shown as a dash-dotted line. In the following, the second undercut 110bbb and the further second undercut 110bbb′ will also be referred to as second undercut 110bbb, 110bbb′. The weight and weight distribution of the second measurement body housing part 11b are adjusted via the size and shape of the second undercut 110bbb, 110bbb′ so that the principal axis of inertia X of the measurement body 1, 1′ in the attached state lies on the longitudinal axis A.

By means of balancing, the two measurement body parts 1a, 1b are matched with each other in terms of their weight and weight distribution. The two balanced measurement body parts 1a, 1b have the same weight and the same weight distribution.

Balancing accuracy is expressed as the balancing quality according to standard DIN ISO 1940-1. Preferably, the balancing quality of the measurement body 1, 1′ is less than or equal to 10, preferentially less than or equal to 5.

Balancing minimizes the interference torque that is caused by a static imbalance and a dynamic imbalance and the measurement accuracy is increased. Furthermore, minimization of the interference torque due to balancing also represents a standardization of the measurement signals. In this way, the measurement signals obtained with measurement bodies 1, 1′ of different cavity diameters D10, D10′ will be comparable because for all measurement bodies 1, 1′ the center of gravity S of the measurement body 1, 1′ lies on the longitudinal axis A and, further, the principal axis of inertia X of the measurement body 1, 1′ lies on the longitudinal axis A.

Preferably, the first housing cavity 110a, 110a′ in the first measurement body housing part 11a is manufactured in an additive manner because this is the only way to produce the first undercut 110aaa, 110aaa′ with the preferred balancing quality. Preferably, the second housing cavity 110b, 110b′ in the second measurement body housing part 11b is also manufactured in an additive manner because this is the only way to produce the second undercut 110bbb, 110bbb′ with the preferred balancing quality.

As schematically shown in FIG. 4, the measuring unit 12 comprises a support unit 121, a strain gauge 122 and an electrical contacting member 123.

The support unit 121 is hollow-cylindrical in shape. In the view according to FIG. 4 and the exploded view according to FIG. 5, the support unit 121 is made from a plurality of parts. Preferably, the support unit 121 is bisected in two support members 121a, 121b in a plane lying in the longitudinal axis A and the two support members 121a, 121b have the shape of congruent halves of hollow cylinders. The two support members 121a, 121b are made of mechanically resistant material such as metal, plastics and the like.

The two support members 121a, 121c comprise plug members 121c such as snap hooks and the like. The plug members 123c are located at the ends of the two support members 121a, 121b. The plug members 121c are configured to form a detachable connection with each other by a form locking connection.

The support unit 121 is configured to support the strain gauge 122 and the contacting member 123. The support unit 121 supports the strain gauge 122 on an inner lateral surface that faces towards the shaft W, W′ in a radial direction.

The strain gauge 122 is configured to generate a measurement signal MS under the effect of the torque M. The strain gauge 122 may be a full bridge, half bridge or quarter bridge. The strain gauge 122 preferably generates the measurement signal MS with a bandwidth of 5 kHz. The measurement signal MS is an electrical voltage. The strain gauge 122 is electrically connected to the electrical contacting member 123 by electrical conductors. The electrical conductors conduct the measurement signal MS to the electrical contacting member 123.

The electrical contacting member 123 is configured to transmit the measurement signal MS through the support member 121 to an outer lateral surface facing away from the shaft W, W′ in a radial direction.

The view according to FIG. 4 shows the measurement body 1, 1′ in the opened state. The views according to FIGS. 2 and 3 show the measurement body 1, 1′ in the closed state. When the measurement body 1, 1′ is in the closed state, the electrical contacting member 123 and the measuring amplifier unit 13 are configured to be electrically connected to each other via electrical contacts. The electrical contacts transmit the measurement signal MS to the measuring amplifier unit 13.

The measuring amplifier unit 13 comprises an amplifier electrical circuit 131 with an operational amplifier. The amplifier electrical circuit 131 is configured to amplify the measurement signal MS. The amplified measurement signal MS is also an electrical voltage. The amplifier electrical circuit 131 amplifies the measurement signal MS by adjustable amplification factors of 101, 102, 103, 104 and the like. As schematically shown in FIG. 5 for example, the measuring amplifier unit 13 is electrically connected to the telemetry unit 14 via electrical conductors. The electrical conductors transmit the amplified measurement signal MS to the telemetry unit 14. Further, the electrical conductors transmit control data SD to the measuring amplifier unit 13.

As schematically shown in FIG. 5 for example, the telemetry unit 14 comprises a telemetry electrical circuit 141 and a rotor antenna 142.

The telemetry electrical circuit 141 comprises an analog/digital converter and is configured to digitize the amplified measurement signal MS to obtain measurement data MD. The measurement data MD are binary number sequences, preferably with a 16-bit resolution.

The rotor antenna 142 is configured to send measurement data MD to the evaluation unit 2 by wireless transmission. For this purpose, the evaluation unit 2 comprises a stator antenna 20 as schematically shown in FIG. 1 for example. The stator antenna 20 is configured to receive measurement data MD sent by the rotor antenna 142. Wireless data transmission between the rotor antenna 142 and the stator antenna 20 is bidirectional. The stator antenna 20 can send control data SD to the rotor antenna 142 and the rotor antenna 142 can receive control data SD sent from the stator antenna 20. Measurement data MD and control data SD are sent and received in the form of electromagnetic waves in this wireless transmission. Preferably, the rotor antenna 142 and the stator antenna 20 transmit measurement data MD and control data SD by wireless transmission in the Industrial Scientific and Medical (ISM) band from 2,402 GHz to 2,480 GHz. In FIG. 1, wireless transmission of the measurement data MD and control data SD is represented schematically as curved circle segments.

As schematically shown in FIG. 1 for example, the stator antenna 20 is electrically connected to the evaluation unit 2 via an electrical data line 21. The electrical data line 21 transmits measurement data MD to the evaluation unit 2 and transmits control data SD to the stator antenna 20.

The energy storage unit 15 comprises at least one electrical energy storage device such as a rechargeable battery, a non-rechargeable battery and the like. Preferably, the energy storage unit 15 is a lithium-ion battery, a lithium polymer battery, a zinc-air battery and the like. The energy storage unit 15 is configured to supply electrical energy to the measurement body 1, 1′ for an operating period of at least 40 hours. The energy storage unit 15 is small in size with a low weight. In the exploded view according to FIG. 5, the energy storage unit 15 comprises four lithium-ion batteries serving as storage elements, each having a capacity of 715 mAh, a weight of 20 g and outer dimensions with a length of 49 mm long and a diameter of 14 mm.

The energy storage unit 15 comprises an energy supply member 151. When the measurement body 1, 1′ is in the closed state, the energy supply member 151, the measuring amplifier unit 13 and the telemetry unit 14 are configured to be electrically connected to each other via electrical contacts. Electrical energy is supplied from the energy storage unit 15 in the second measurement body housing part 11b to the measuring amplifier unit 13 and the telemetry unit 14 in the first measurement body housing part 11a through these electrical contacts.

Furthermore, the energy storage unit 15 comprises a power supply connection 152. The power supply connection 152 is a plug connector such as USB-C and the like. In the view according to FIG. 4 and the exploded view according to FIG. 5, the power supply connection 152 is arranged in the first measurement body closure part 11aa. The power supply connection 152 is electrically connected to the measuring amplifier unit 13 in the first measurement body housing part 11a. Thus, the power supply connection 152 is electrically connected via the measuring amplifier unit 13 to the energy supply member 151 and the energy storage unit 15 in the second measurement body housing part 11b when the measurement body 1, 1′ is in the closed state. The energy storage unit 15 can be charged with electrical energy by connecting an external electrical power supply to the power supply connection 152 by means of a cable. The measurement body 1, 1′ attached to the shaft W, W′ is charged in a quick and easy manner. It is not necessary to remove the measurement body 1, 1′ from the shaft W, W′ for this purpose. In a charging time of less than 30 minutes, the empty energy storage unit 15 is charged to at least 80% with electrical energy.

In addition, the energy storage unit 15 of the measurement body 1, 1′ attached to the shaft W, W′ can be replaced in an easy and quick manner. It is not necessary to remove the measurement body 1, 1′ from the shaft W, W′ for this purpose. The second housing cavity 110b, 110b′ is accessible from the outside of the measurement body 1, 1′ by opening the second measurement body closure part 11bb. Then it is possible to remove the energy storage unit 15 from the second housing cavity 110b, 110b′. A new energy storage unit 15′ can be inserted into the second housing cavity 110b, 110b′ replacing the removed energy storage unit 15. Thus, when the four lithium-ion batteries depicted as the storage elements in the exploded view according to FIG. 5 are empty, they can be replaced by charged lithium-ion batteries. Afterwards, the second housing cavity 110b, 110b′ is closed by the second measurement body closure part 11bb. Replacing the energy storage unit 15 is done in less than 5 mins.

As schematically shown in FIG. 1 for example, the evaluation unit 2 comprises at least one data memory 22, at least one data processor 23, at least one input/receiving unit 24 and at least one output unit 25.

The evaluation unit 2 is configured to evaluate the measurement data MD and to generate control data SD for controlling the measurement body 1, 1′.

The data memory 22 in the evaluation unit 2 stores an evaluation program P that can be loaded into the data processor 23. The evaluation program P loaded into the data processor 23 generates commands, which commands are automatically executed by the evaluation unit 2. The adverb “automatically” in the sense of the present invention means that the commands generated by the evaluation program P are executed by the evaluation unit 2 without any involvement of a human person.

It is possible to operate the evaluation unit 2 by using the input/receiving unit 24. The verb “operate” in the context of the present invention means that a human person can enter commands via the input/receiving unit 24, which commands are executed by the evaluation unit 2. The input/receiving unit 24 may be a keyboard for entering commands, an antenna for receiving commands and the like. Commands are entered by the keyboard in the form of a character string for which the evaluation unit 2 generates control data SD. The commands are received by the antenna as electromagnetic waves for which the evaluation unit 2 generates control data SD.

Thus, the evaluation unit 2 generates control data SD for controlling the measurement body 1, 1′ according to the commands of the evaluation program P or according to the commands entered at the input/receiver unit 24. The control data SD executes a variety of commands.

Thus, it is possible to start or stop the measurement body 1, 1′ by the control data SD. For this purpose, the evaluation unit 2 generates control data SD comprising information about starting or stopping the measurement body 1, 1′ and transmits it to the measuring amplifier unit 13. The measuring amplifier unit 13 starts or stops the measurement body 1, 1′ according to the control data SD.

Furthermore, control data SD can also be used for setting the zero point of the amplifier electrical circuit 131. The zero point may drift over time and under external influences such as temperature. The zero point must be adjusted to achieve a high level of measurement accuracy. The zero point desirably should not differ from the actual zero point by more than 10% (upper and lower limit). For a zero point that is not within these desired limits, the evaluation program P determines a new zero point lying within the limits. Alternatively, a new zero point is set according to commands entered via the input/receiving unit 24. Thus, the evaluation unit 2 generates control data SD indicating the new zero point and transmits the control data SD to the measuring amplifier unit 13. The amplifier electrical circuit 131 then uses the new zero point as specified in the control data SD.

In addition, the control data SD can also be used for setting the gain factor of the amplifier electrical circuit 131. Each amplified measurement signal MS can be represented up to a maximum value or final value (full scale). For the best possible representation, the amplified measurement signal MS should not exceed the final value (upper limit), and it should also not be more than one order of magnitude smaller than the final value (lower limit). In case the amplified measurement signal MS is not within these limits, the evaluation program P determines a different amplification factor for the amplified measurement signal MS to lie within the limits. Alternatively, a command entered via the input/receiver unit 24 serves to set such a different gain factor. Thus, the evaluation unit 2 generates control data SD indicating the amplification factor and transmits the control data SD to the measuring amplifier unit 13. The amplifier electrical circuit 131 amplifies the measurement signal MS according to the control data SD.

Optionally, as schematically shown in FIG. 1 for example, the device V comprises an angle of rotation sensor 30. The angle of rotation sensor 30 may be an optical sensor, a magnetic sensor and the like detecting the angle of rotation a of the shaft W, W′ in a contactless manner and generating an angle of rotation signal WS for the detected angle of rotation a. The angle of rotation sensor 30 is electrically connected to the evaluation unit 2 by an electrical signal line 31. The electrical signal line 31 transmits an angle signal WS to the evaluation unit 2.

The evaluation unit 2 is configured to evaluate the angle signal WS. From the angle signal WS, the evaluation program P loaded into the data processor 23 generates information concerning the direction of rotation of the shaft W, W′ and the angular position of the shaft W, W′.

The measurement body 1, 1′ is attached to the shaft W, W′ in a three-step process.

In a first step, the two support members 121a, 121b are placed on the shaft W, W′ and connected to each other via the plug members 121.

In a second step, the two measurement body housing parts 11a, 11b are placed in the opened state on the support unit 121.

In a third step, the two measurement body housing parts 11a, 11b are connected to each other by means of the connecting unit 112 by pivoting them about the longitudinal axis A. When the measurement body 1, 1′ is in the closed state, the electrical contacting member 123 and the measuring amplifier unit 13 are electrically connected to each other by electrical contacts. In the closed state of the measurement body 1, 1′, the energy supply member 151, the measuring amplifier unit 13 and the telemetry unit 14 are electrically connected to each by via electrical contacts, and the measuring amplifier unit 13 and the telemetry unit 14 in the first measurement body housing part 11a are supplied with electrical power by the energy storage unit 15 in the second measurement body housing part 11b.

### LIST OF REFERENCE NUMERALS

α angle of rotation
A longitudinal axis
B first section line
B-B first cross-section
C second section line
C-C second cross-section
D10 cavity diameter
D10′ cavity diameter
M torque
MD measurement data
MS measurement signal
P evaluation program
S center of gravity
SD control data
V device
W, W shaft
WD, WD′ shaft diameter
WS angle signal
X inertia axis
1, 1′ measurement body
1a, 1b′ measurement body part
10, 10′ axial cavity
11 measurement body housing
11a, 11b measurement body housing part
11aa, 11bb measurement body closure part
110a, 110a′ first housing cavity
110aa first edge
110aa′ first edge
110aaa first undercut
110aaa′ first undercut
110b, 110b′ second housing cavity
110bb second edge
110bb′ second edge
110bbb second undercut
110bbb′ second undercut
11 hinge unit
111a pin
111b socket
112 connecting unit
112a screw
112aa through hole
112b threaded hole
12 measuring unit
121 support unit
121a support member
121b support member
121c plug member
122 strain gauge
123 electrical contacting member
13 measuring amplifier unit
131 amplifier electrical circuit
14 telemetry unit
141 telemetry electrical circuit
142 rotor antenna
15, 15′ energy storage unit
151 energy supply member
152 power supply connection
20 stator antenna
21 electrical data line
2 evaluation unit
22 data memory
23 data processor
24 input/receiving unit
25 output unit
30 angle of rotation sensor
31 electrical signal line

What is claimed is:

1. A device for measuring the torque of a shaft rotating about a longitudinal axis of the shaft, the device comprising:
a measurement body that is configured to be attached to the shaft and rotate with the shaft about the longitudinal axis of the shaft in an attached state;
wherein the measurement body includes a measuring unit, a measuring amplifier unit connected to the measuring unit, and a telemetry unit connected to the telemetry unit;
wherein the measuring unit is configured to generate a measurement signal under the effect of a torque in the attached state;
wherein the measuring amplifier unit is configured to amplify the measurement signal;
an evaluation unit;
wherein the telemetry unit is configured to digitize the amplified measurement signal and transmit the digitized and amplified measurement signal by wireless transmission to the evaluation unit;
wherein the measurement body has a principal axis of inertia that lies on the longitudinal axis in the attached state.

2. The device according to claim 1, wherein the measurement body includes a measurement body housing that is fabricated from a plurality of parts and includes a first measurement body housing part having a first housing cavity that receives the measuring amplifier unit and the telemetry unit.

3. The device according to claim 2, further comprising an energy storage unit;
wherein the measurement body housing includes a second measurement body housing part having a second housing cavity that receives the energy storage unit.

4. The device according to claim 3, wherein the measurement body housing includes a second measurement body closure part that closes the second housing cavity that receives the energy storage unit;
wherein the second measurement body closure part is configured to be opened so that the second housing cavity is accessible from the outside of the measurement body in the attached state;
wherein the energy storage unit is configured to be removable from the second housing cavity to permit insertion of a new energy storage unit into the second housing cavity; and
wherein the second housing cavity is configured to be closed by means of the second measurement body closure part.

5. The device according to claim 3, wherein the first housing cavity includes a first undercut;
wherein the weight and weight distribution of the first measurement body housing part are configured in relation to the size and shape of the first undercut so that the principal axis of inertia of the measurement body in the attached state lies on the longitudinal axis;
wherein the second housing cavity includes a second undercut; and
wherein the weight and weight distribution of the second measurement body housing part are configured in relation to the size and shape of the second undercut so that the principal axis of inertia of the measurement body in the attached state lies on the longitudinal axis.

6. The device according to claim 3, wherein the first and second measurement body housing parts have the shape of congruent halves of hollow cylinders.

7. The device according to claim 3, wherein the first and second measurement body housing parts are additively manufactured parts.

8. The device according to claim 1, wherein the measurement body is hollow-cylindrical in shape and includes an axial cavity that has a cavity diameter equal to a shaft diameter of the shaft to which the measurement body is configured to be attached.

9. The device according to claim 1, wherein the measuring unit includes a support unit and a strain gauge;
wherein the support unit includes an inner lateral surface and supports the strain gauge on the inner lateral surface that faces towards the shaft in a radial direction; and
wherein the strain gauge is configured to generate a measurement signal under the effect of the torque.

10. The device according to claim 9, wherein the support unit includes a plurality of parts and includes a first support member and a second support member; and
wherein the first and second support members have the shape of congruent halves of hollow cylinders.

11. The device according to claim 10, wherein each of the first and second support members includes a plug member; and
wherein each of the plug members is configured to form a detachable connection with each other plug member by means of a form locking connection.

12. A method for measuring the torque of a rotating shaft, which elongates along a longitudinal axis, using a device that includes a measurement body and an evaluation unit; which measurement body has a principal axis of inertia and includes a measuring unit, a measuring amplifier unit and a telemetry unit; wherein the method comprising the following steps:
the measurement body is attached to the shaft in a manner such that the principal axis of inertia of the measurement body lies on the longitudinal axis of the shaft in the attached state;
wherein the shaft is set in rotation about the longitudinal axis of the shaft by the torque that is to be measured by the device;
wherein the measuring unit generates a measurement signal under the effect of the torque;
wherein the measuring amplifier unit amplifies the measurement signal; and
wherein the telemetry unit digitizes the amplified measurement signal and transmits the digitized and amplified measurement signal by wireless transmission to the evaluation unit.

13. The method according to claim 12, wherein the measuring unit includes a support unit and a strain gauge, which support unit is fabricated from a plurality of parts and includes a first support member and a second support member, which first and second support members include plug members; and in a step of attaching the measurement body to the shaft the first and second support members are placed on the shaft and connected to each other by the plug members.

14. The method according to claim 13, wherein the measurement body includes a measurement body housing that is fabricated from a plurality of parts and includes a first measurement body housing part and a second measurement body housing part, wherein each of the first measurement body housing part and the second measurement body housing part is disposable between an opened state and a closed state and includes a hinge unit that holds the first and second measurement body housing parts together so that they can pivot about the longitudinal axis; and
wherein during the step of attaching the measurement body to the shaft each of the first and second measurement body housing parts is placed in the opened state on the support unit.

15. The method according to claim 14, wherein a connecting unit connects the first and second measurement body housing parts so that they are releasably closed; and
wherein during the step of attaching the measurement body to the shaft the two measurement body housing parts are connected to each other by means of the connecting unit by pivoting each of the first and second measurement body housing parts about the longitudinal axis.

16. The device according to claim 3, further comprising a second measurement body;
wherein the measurement body is hollow-cylindrical in shape and includes an axial cavity that has a cavity diameter equal to a shaft diameter of the shaft to which the measurement body is configured to be attached; and
wherein the second measurement body is hollow-cylindrical in shape and includes a second axial cavity that has a second cavity diameter equal to a shaft diameter of the shaft to which the second measurement body is configured to be attached.
